(19) United States
(12) Patent Application Publication
(10) Pub. No.: US 2025/0084333 A1
(43) Pub. Date: Mar. 13, 2025

(54) Sodium Polyacrylate Mixture Buffer Tank Solution for Fuel Quality and Tank Protection of Fuel Storage

(71) Applicant: Stephen Schultz, Chuluota, FL (US)

(72) Inventor: Stephen Schultz, Chuluota, FL (US)

(21) Appl. No.: 18/827,525

(22) Filed: Sep. 6, 2024

Related U.S. Application Data
(60) Provisional application No. 63/537,723, filed on Sep. 11, 2023.

(51) Int. Cl. C10L 1/197

(52) U.S. Cl. CPC C10L 1/197; C10L 2290/08

(57) ABSTRACT

Sodium Polyacrylate mixture buffer tank solution for fuel quality and tank protection of fuel storage is disclosed. This invention uses a Sodium Polyacrylate mixture to remove water from fuel which is more efficient because it works without the use of filters, power, or fuel additives. This system also uses an off-line buffer tank that does not interfere with the on-site operations and allows the Sodium Polyacrylate mixture to extract water from fuel without power, agitation, filtration, or mixing.

### BACKGROUND OF THE INVENTION

### Problem Solved

When diesels or other fuels with high water-content, fuel containing suspended water and other contaminants are allowed to accumulate and remain at the bottom of fuel storage tanks they cause tank corrosion, bacteria-growth, fuel degradation, fuel-quality reductions, and other related problems.

Existing solutions require large, expensive, and high-power consumption filtration systems to clean fuel such as flow through filtration cleaning, water coalescing or cyclical fuel cleaning through multiple passes of filtration. Also, existing solutions do not have the efficiency and efficacy of Sodium Polyacrylate mixtures for extracting bound, suspended, and emulsified water from fuel that extracts water from fuel without the use of power or movement of the fuel.

The systems and methods disclosed herein use a Sodium Polyacrylate mixture to remove water from fuel which is more efficient because it works without the use of filters, power, or fuel additives to remove water from fuel. This system also uses an off-line buffer tank that does not interfere with the on-site operations and allows the Sodium Polyacrylate mixture to extract water from fuel without power, agitation, filtration, or mixing.

### DETAILED DESCRIPTION OF THE INVENTION

As stated above, when diesels or other fuels with high water-content, fuel containing suspended water and other contaminants are allowed to accumulate and remain at the bottom of fuel storage tanks they cause tank corrosion, bacteria-growth, fuel degradation, fuel-quality reductions, and other related problems. The systems and methods disclosed here solve this problem.

Exemplary embodiments provide a more efficient process for removing and preventing off-specification fuel, high water-content fuel, fuel containing suspended water, dirt, bacteria, and other contaminants from the bottom of fuel storage tanks. These processes include a more efficient and effective process for extracting and removing bound water, suspended water, emulsified water, and contaminants from fuels to restore fuel to on-specification fuel and improve fuel quality, make use of dead stock, and protect the fuel storage tank from corrosion, bacteria-growth, fuel degradation and other problems caused by high water-content fuel and particle accumulation in fuel storage tanks.

Exemplary embodiments of the present disclosure differ from what currently exists. Unlike other solutions, this invention removes high-water content fuel, off-specification fuel, dirt, bacteria, and other contaminants from fuel storage tanks through particle filtration into a buffer tank where a Sodium Polyacrylate mixture is used in a passive manner to extract bound water, emulsified water, and micro-particles from the fuel from inside the buffer tank. Exemplary embodiments allow Sodium Polyacrylate mixtures to be more readily and safely utilized in fuel depots, fuel terminal storage facilities and for other fuel storage tanks.

Exemplary embodiments of the present disclosure represent an improvement on what currently exists. Unlike existing solutions, embodiments of the present disclosure remove high-water content fuel, off-specification fuel, dirt, bacteria, and other contaminants from fuel storage tanks through particle filtration into a buffer tank where a Sodium Polyacrylate mixture is used in a passive manner to extract bound water, emulsified water, and micro-particles from the fuel from inside the buffer tank. Exemplary embodiments allow Sodium Polyacrylate mixtures to be more readily and safely utilized in fuel depots, fuel terminal storage facilities and for other fuel storage tanks.

Existing systems require filters, agitators, water coalescing and/or water separators to remove bound, emulsified, and suspended water from fuel. These systems are not as efficient as the Sodium Polyacrylate mixtures at extracting water from fuels. Existing systems are often more expensive, require frequent water filter element changes, multiple passes and use a higher consumption of power. As well, existing solutions require constant movement of the fuel to produce results while the Sodium Polyacrylate mixture buffer tank does not require movement of the fuel to produce results.

Embodiments of the present disclosure use a Sodium Polyacrylate mixture to remove water from fuel which is more efficient because it works without the use of filters, power, or fuel additives to remove water from fuels. This system also uses an off-line buffer tank that does not interfere with the on-site operations and allows the Sodium Polyacrylate mixture to extract water from fuel without power, agitation, filtration, or mixing.

The solution can be used to produce higher purity fuels by storing fuels in a buffer tank with a Sodium Polyacrylate mixture in the same or similar system without or without the filtration components.

### The Version of The Invention Discussed Here Includes:

1. Depot, Terminal, or Fuel Storage Tank
2. Water Drain-Off
3. Fuel Transfer From Main Tank
4. Solids Filtration
5. Fuel Transfer Into Sodium Polyacrylate Mixture Buffer Tank
6. Sodium Polyacrylate Mixture Buffer Tank
7. Sodium Polyacrylate Mixture
8. Fuel Transfer From Buffer Tank
9. Post-Treatment Safety Filter
10. Fuel Transfer Back to Fuel Supply

### Relationship Between the Components

Item 1 is the fuel storage tank which stores the supply of fuel. Item 2 is the optional water drain-off that allows for excess free water to be drained off prior to transfer to the buffer tank. Item 3 is the fuel transfer from the main tank to the solids filtration toward the buffer tank. Item 4 is the solids filtration that the fuel passes through on its way to the buffer tank that will remove much of the solid particulate from the transferred fuel. Item 5 is the solids filtered fuel being further transferred directly into the buffer tank. Item 6 is the buffer tank where the fuel is treated with Item 7, the Sodium Polyacrylate mixture. The fuel remains in item 6 for a specified period of time to allow item 7 to remove water and microparticles from the fuel. Item 7 extracts and captures water from the fuel by causing water molecules to be attracted away from fuel molecules and then encapsulates them away from the fuel. After this treatment period in the buffer tank, items 8 transfers the treated fuel through item 9 which is an optional post-treatment safety filter to assure that Sodium Polyacrylate mixture particles do not pass into the fuel supply. Item 10 is the fuel transfer back to the fuel supply which ends this process.

### How the Invention Works

In exemplary embodiments, each component works in succession with the previous component to implement the stages of filtration and treatment. The fuel storage tank (Item 1) is the tank which stores the supply of fuel. The water drain-off (Item 2) allows for excess free water to be drained off prior to transfer to reduce the water extraction burden on the Sodium Polyacrylate mixture in the buffer tank. To begin the process the bottom section of fuel or dead stock, which is determined by situational requirement, is transferred (Item 3) through the solids filtration (Item 4) to remove dirt, bacteria, corrosion pollution and other solid contaminants before it is transferred (Item 5) into the Sodium Polyacrylate mixture buffer tank (Item 6). When the fuel has been transferred into the buffer tank (Item 6), it will remain in the tank for a period of hours or days to be treated by the Sodium Polyacrylate mixture (Item 7). During this treatment, the Sodium Polyacrylate mixture will extract, and capture bound, suspended, and emulsified water from the fuel which also removes micro-contaminants that can damage fuel tanks and other equipment as well as creates an improvement in fuel-quality. After treatment in the buffer tank (Item 7), the fuel is transferred (Item 8) from the buffer tank (Item 7) and through the optional safety particulate filter (Item 9) to safeguard from Sodium Polyacrylate mixture particles from being transferred back into the fuel supply (Item 10). After the buffer tank treated fuel is transferred back into the fuel supply, this process is complete.

### How to Make the Invention

To construct this solution the solids filtration, the buffer tank and the optional safety filter should be installed in the appropriate location on-site so that the fuel transfer passes first through the solids filtration before transferring into the buffer tank and so that the fuel is transferred through the safety filter after treatment and before transfer back to the main tank or fuel supply. From there, hose and/or pipe should be connected from the fuel supply or main tank to the solids filter housing. Also, hose and/or pipe should be connected from the solids filter housing to the buffer tank. In the same manner, hose and/or pipe should connect from the buffer tank to the optional safety filter. And then hose and/or pipe should connect from the optional safety filter to the fuel supply, back to the main tank or to the location that is deemed appropriate. A proper Sodium Polyacrylate mixture should be installed at the bottom of the buffer tank where it will treat the fuel on gravity without artificial agitation.

Hose and/or pipe segments as well as hose and/or pipe connections are needed to transfer fuel from the supply tank to the solids filtration, to transfer fuel from the solids filtration to the buffer tank, to transfer fuel from the buffer tank to the optional safety filter and to transfer the fuel from the optional safety filter back to the supply. The buffer tank is required to store the fuel during treatment with the Sodium Polyacrylate mixture that is in the bottom of the buffer tank. Also required is the Sodium Polyacrylate mixture that treats the fuel in the buffer tank.

Multiple filters can be utilized to improve the solids and safety filtration on either side of the buffer tank. The buffer tank can be made larger or smaller to accommodate specific use applications. The suction line in the buffer tank can be raised to provide more water capture volume under the suction line before the Sodium Polyacrylate mixture needs to be changed out. A floating suction can be used to manage fuel and Sodium Polyacrylate mixture growth within the buffer tank. A suction screen can be used to prevent the Sodium Polyacrylate mixture from going into the suction line. A truck, trailer, train, or other mobile vessel can be used to transfer the fuel when the buffer tank is located further from the fuel supply. The main tank may not need to have a water drain-off if it is deemed not to have significant free water accumulation and in this case the water drain-off step can be skipped, and the rest of the process can proceed without a water drain-off. Fuel from any source, not only a storage tank, can be transferred into a buffer tank with a Sodium Polyacrylate mixture, to be treated.

### How to Use the Invention

It should be determined in each cycle whether a water drain-off is necessary for that cycle. If it is deemed necessary, the water drain-off should be made until the appropriate indication is made that the water drain-off should cease. If a water drain-off is determined not to be needed, the water drain-off step can be skipped. After it is determined that the water drain-off is complete or when it is determined to begin the fuel transfer to the buffer tank, fuel from the bottom of the source tank or from the fuel supply should be pumped or drained through the solids filtration and into the buffer tank containing the Sodium Polyacrylate mixture. Once the apportioned volume of fuel has been transferred from the fuel supply or storage tank into the buffer tank through the solids filter, the transfer should be shut off and the apportioned fuel should be left to remain in the buffer tank for a specified time for treatment of the fuel by the Sodium Polyacrylate mixture. After the treatment period, the treated fuel should be pumped from the buffer tank through an optional safety filter to collect any Sodium Polyacrylate mixture that might come through with the flow of fuel. From this optional safety filter, the treated fuel should be pumped back into the source tank, to the fuel supply or to any other location that is determined. If the optional safety filter is not used, the fuel can be pumped directly from the buffer tank to the source tank, fuel supply or other location.

Additionally: exemplary embodiments can be used with jet fuel, gasoline, or other similar viscosity oils.

Also, exemplary embodiments can be used to produce higher purity fuels by storing fuels in a buffer tank with a Sodium Polyacrylate mixture in the same or similar system without or without the filtration components.

### BRIEF DESCRIPTION OF THE DRAWINGS

FIG. 1 illustrates a flow diagram of an exemplary embodiment of a system for implementing a process according to an embodiment of the present disclosure.

FIG. 2 illustrates a flow diagram of an alternative exemplary embodiment of the system shown in FIG. 1.

FIG. 3 is a flow chart showing an exemplary process according to an embodiment of the present disclosure, which may be beneficially implemented using the system as shown in FIG. 1.

FIG. 4 is a flow chart showing an alternative embodiment of the process shown in FIG. 3, which may be beneficially implemented using the system as shown in FIG. 2.

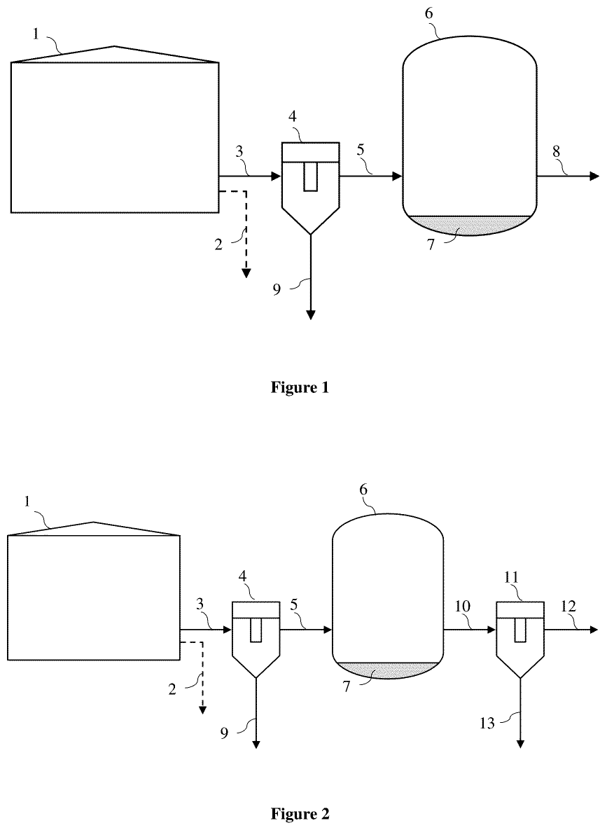

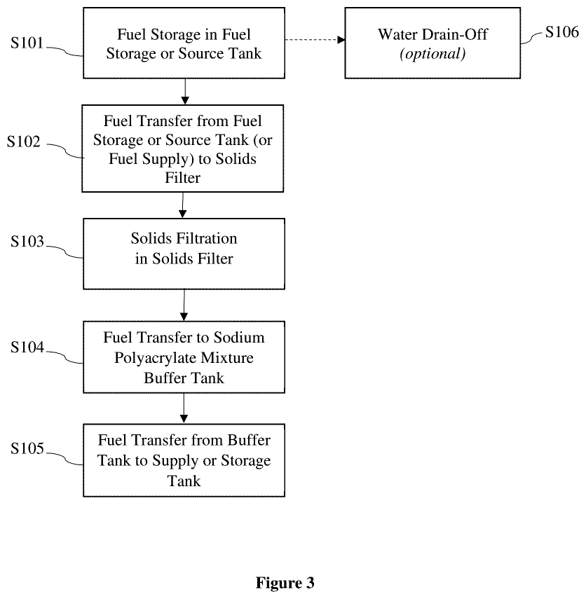

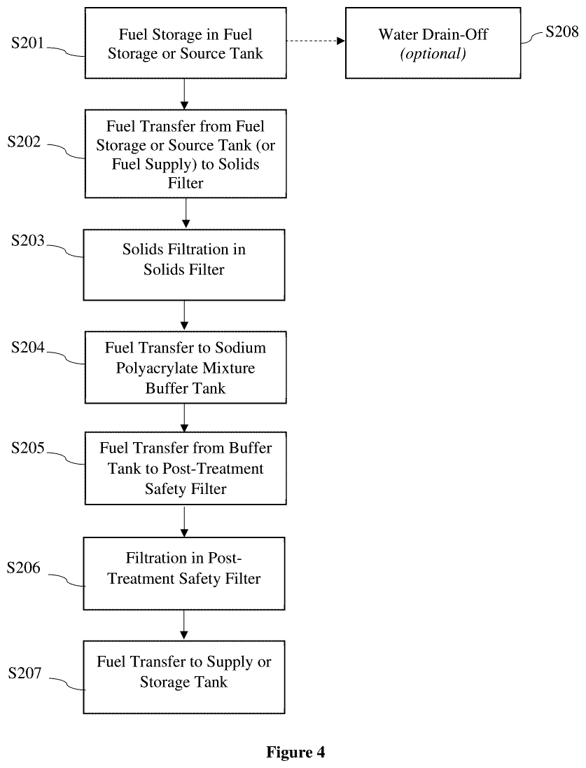

The following reference numerals are provided in the drawings:
1—Fuel storage or source tank
2—Water drain-off pipeline
3—Fuel transfer pipeline from fuel storage or source tank (or fuel supply) to solids filter
4—Solids filter
5—Fuel transfer pipeline to sodium polyacrylate (SAP) mixture buffer tank;
6—SAP mixture buffer tank
7—SAP mixture (resting on bottom of buffer tank)
8—Fuel transfer pipeline from buffer tank to supply or storage tank
9—Particulate solids
10—Fuel transfer pipeline from buffer tank to post-treatment safety filter
11—Post-treatment safety filter
12—Fuel transfer pipeline to supply or storage tank
13—Residue
S101—Step of fuel storage in fuel storage or source tank
S102—Step of fuel transfer from fuel storage or source tank (or fuel supply) to solids filter
S103—Step of solids filtration in solids filter
S104—Step of fuel transfer to SAP mixture buffer tank
S105—Step of fuel transfer from buffer tank to supply or storage tank
S106—Step of water drain-off (optional)
S201—Step of fuel storage in fuel storage or source tank
S202—Step of fuel transfer from fuel storage or source tank (or fuel supply) to solids filter
S203—Step of solids filtration in solids filter
S204—Step of fuel transfer to SAP mixture buffer tank
S205—Step of fuel transfer from buffer tank to supply or storage tank
S206—Step of filtration in post-treatment safety filter
S207—Step of fuel transfer to supply or storage tank
S208—Step of water drain-off (optional)

1. A system for improving fuel quality, the system comprising:
a fuel storage tank storing a supply of fuel; and
a fuel transfer in fluid communication with the fuel storage tank and a solids filtration, the solids filtration in fluid communication with a buffer tank, the fuel being treated in the buffer tank with a Sodium Polyacrylate mixture.

2. The system of claim 1, further comprising a water drain-off in fluid communication with the fuel storage tank, the water drain-off allowing for excess free water to be drained off prior to transfer to the buffer tank.

3. The system of claim 1, further comprising a post-treatment safety filter in fluid communication with the buffer tank, the post-treatment safety filter configured to prevent the Sodium Polyacrylate mixture from exiting the buffer tank.

4. A method for improving fuel quality, the method comprising:
passing fuel from a fuel storage tank to a buffer tank in fluid communication with the fuel storage tank, the buffer tank containing a Sodium Polyacrylate mixture;
extracting water from the fuel by the Sodium Polyacrylate mixture; and
passing the fuel back to the fuel storage tank.

5. The method of claim 4, further comprising passing the fuel from the fuel storage tank through a solids filtration between the fuel storage tank and the buffer tank.

6. The method of claim 4, further comprising passing the fuel from the buffer tank through a post-treatment safety filter.

7. A system for removing excess bound water from liquid fuels, the system comprising:
a fuel storage tank storing a supply of fuel; and
a fuel transfer in fluid communication with the fuel storage tank and a solids filtration, the solids filtration in fluid communication with a buffer tank, the fuel being treated in the buffer tank with a Sodium Polyacrylate mixture.

8. The system of claim 7, further comprising a water drain-off in fluid communication with the fuel storage tank, the water drain-off allowing for excess free water to be drained off prior to transfer to the buffer tank.

9. The system of claim 7, further comprising a post-treatment safety filter in fluid communication with the buffer tank, the post-treatment safety filter configured to prevent the Sodium Polyacrylate mixture from exiting the buffer tank.

10. A method for removing excess bound water from liquid fuels, the method comprising:
passing fuel from a fuel storage tank to a buffer tank in fluid communication with the fuel storage tank, the buffer tank containing a Sodium Polyacrylate mixture;
extracting water from the fuel by the Sodium Polyacrylate mixture; and
passing the fuel back to the fuel storage tank.

11. The method of claim 10, further comprising passing the fuel from the fuel storage tank through a solids filtration between the fuel storage tank and the buffer tank.

12. The method of claim 10, further comprising passing the fuel from the buffer tank through a post-treatment safety filter.
